(19) United States
(12) Patent Application Publication
(10) Pub. No.: US 2012/0165104 A1
(43) Pub. Date: Jun. 28, 2012

(54) GREASE COMPOSITION

(76) Inventor: Franck Bardin, Vienne (FR)

(21) Appl. No.: 13/394,445

(22) PCT Filed: Sep. 10, 2010
(86) PCT No.: PCT/IB10/54099

§ 371 Date: Mar. 6, 2012

(30) Foreign Application Priority Data
Sep. 10, 2009 (FR) 0904326

(51) Int. Cl. C10M 103/06; F16D 3/10

(52) U.S. Cl. 464/7; 508/165; 508/166; 508/167

(57) ABSTRACT

A grease composition including:
one or more mineral, synthetic or natural base oils,
a thickener,
at least one solid lubricant constituted by one or more transition metal chalcogenides with an inorganic fullerene structure,
one or more organophosphorus and/or organophosphorus-sulphur anti-wear and/or extreme pressure additives.
   A grease composition as defined above is used in the constant velocity joints of the transmissions of motor vehicles. Constant velocity joints containing a grease as defined above are also provided.

### CROSS-REFERENCE TO RELATED APPLICATIONS

This application is a National Phase Entry of International Application No. PCT/IB2010/054099, filed on Sep. 10, 2010, which claims priority to French Patent Application Serial No. 0904326, filed on Sep. 10, 2009, both of which are incorporated by reference herein.

### BACKGROUND

The present invention relates to grease compositions with a low coefficient of friction, which can be used in particular in constant velocity joints which are used in the transmissions of motor vehicles.

A universal joint or mechanical coupling is a mechanical system comprising several parts that are movable relative to each other, or flexible, which allows the mutual driving of two rotating parts the axes of rotation of which occupy variable relative positions during operation. In other words, this is a connection which makes it possible to transmit the rotation from one shaft to another shaft that is mobile relative to the first. A universal joint is said to have a constant velocity if, at all times, the speeds of rotation of the two shafts are equal.

The movements inside constant velocity joints are complex, with a combination of rolling, sliding and rotation. This results in wear on the contact surfaces of the components, but also significant frictional forces between the surfaces. The wear can result in failure of the joints and the frictional forces can lead to noise, vibrations and jerking in the drive train.

Therefore, the greases used in constant velocity joints must not only have an anti-wear effect, but also have a low coefficient of friction in order to reduce or prevent noise, vibration and jerking. Different additives are known and help to reduce wear and/or friction. Thus, the known greases for constant velocity joints frequently contain anti-wear additives, which are for example phosphorus compounds, or phosphorus-sulphur compounds and friction modifiers, for example organic compounds containing molybdenum, which can have effects on either one of these properties, or even both.

The application EP 0435 745 describes, for example, a grease for constant velocity joints comprising a mineral oil, a polyurea-type thickener, from 0.5 to 5% by weight of molybdenum dithiophosphate (MoDTP) and 0.5 to 5% by weight of molybdenum dithiocarbamate (MoDTC) as a friction modifier (FM), and 0.5 to 10% by weight of ZnDTP as an EP agent, and 0.5 to 60% of a copolymer of ethylene and branched alpha-olefin. The patent EP 0708 172 also describes a grease with a low coefficient of friction for constant velocity joints comprising a base oil, a simple or lithium complex soap thickener, one or more organic components containing molybdenum, of MoDTC or MoDTP type, at least one zinc dithiophosphate, a metal-free phosphorus-sulphur extreme pressure agent, a calcium salt of oxidized wax, of petroleum sulphonate or of alkyl aromatic sulphonates. The patent FR 1 421 105 thus describes the use of solid lubricating products with a laminar crystalline structure in combination with metal salts of oxygenated acids of phosphorus, for lowering the coefficient of friction of greases. The application WO 2007/085643 describes grease compositions with a low coefficient of friction for constant velocity joints comprising a base oil, one or more thiourea-type thickeners, 0.1 to 5% by weight of tungsten disulphide in the form of particles having an average size of less than 10 μm (tanmikB marketed by Nippon Lubricant Ltd), and 0.1 to 5% by weight of one or more zinc dithiophosphates and/or molybdenum dithiocarbamate. U.S. Pat. No. 5,516,439 describes a grease composition comprising (a) a base oil, (b) a lithium-based thickener, (c) a molybdenum compound which is a molybdenum dithiophosphate or a molybdenum dithiocarbamate, (d) a zinc dithiophosphate, (e) a metal salt.

It is also known to use, as friction modifiers, solid lubricants such as molybdenum bisulphide (MoS2) or tungsten bisulphide (WS2) in laminar form or in fullerene form for lowering the coefficient of friction of the greases. Certain publications report the use of metal dichalcogenides in the form of inorganic fullerenes for lowering the coefficient of friction and improving the anti-wear properties of lubricating oils and grease. The publication “Fullerene-like WS2 Nanoparticles: Superior Lubricants for Harsh Conditions”, by Lev Rapoport, Nieles Fleischer, Reshef Tenne Adv. Mat. 2003, 15, 651-655 thus compares the frictional properties of a reference grease constituted by base oil thickened with lithium, then with laminar WS2 and finally fullerene WS2 added. The publication “Modification of contact surfaces by fullerene-like solid lubricant nanoparticles”, by L. Rapoport, V. Leshchinski, Yu. Volovik, M. Lvovsky, O. Nepomnyashchy, Y. Feldman, R. Popovitz-Biro, R. Tenne, Surface and Coating Technology 163-164 (2003) 405-412, compares the same products with respect to their anti-wear properties.

However, no specific combination of metal dichalcogenides in the form of inorganic fullerene with other components of the greases is disclosed. In particular, the effects of the interactions of the metal chalcogenides of the inorganic fullerene type with the thickeners, and the anti-wear, and optionally extreme pressure additives, necessary for the formulation of the commercial greases, are not disclosed in the prior art. These effects could prove to be positive or negative. There is therefore still a need for formulated greases having a coefficient of friction even lower than the greases of the prior art. There is also still a need for such greases with a very low coefficient of friction, simultaneously having anti-wear properties equivalent to or improved relative to the greases of the prior art.

Surprisingly, the Applicant has demonstrated a synergistic effect between transition metal chalcogenides in the form of inorganic fullerenes, used as solid friction modifiers, with organophosphorus-sulphur-type anti-wear and extreme-pressure compounds, in greases thickened in particular with lithium soaps. The combination of these compounds in greases makes it possible to lower the coefficient of friction of said greases well below that of greases containing one or other of these compounds individually. The anti-wear performances of these greases are maintained relative to the known greases containing organic molybdenum compounds as friction modifiers and organophosphorus compounds or organophosphorus-sulphur compounds as anti-wear additives.

### SUMMARY

The present invention relates to grease compositions comprising:
(a) one or more mineral, synthetic or natural base oils,
(b) a thickener,
(c) at least one solid lubricant constituted by one or more transition metal chalcogenides with an inorganic fullerene structure,
(d) one or more organophosphorus and/or organophosphorus-sulphur anti-wear and/or extreme pressure additives.

Preferentially, in the grease compositions according to the invention, the thickener (b) is composed mostly of at least one fatty acid metal soap. Even more preferentially, the fatty acid metal salt(s) constitute(s) at least 50%, preferentially at least 80% by weight of the thickener (b) in said compositions.

According to an embodiment, one or more transition metal chalcogenides with an inorganic fullerene structure used in the grease compositions according to the invention have inorganic phosphate groups grafted on their surface. Preferentially, in the grease compositions according to the invention, the chalcogen of at least one solid lubricant (c) is chosen from S, Se, Te. Preferentially, in the grease compositions according to the invention, the transition metals of at least one solid lubricant (c) are chosen from Mo, W, Zr, Hf, Pt, Re, Ti, Ta, Nb, preferentially Mo and W.

According to a particularly preferred embodiment, in the grease compositions according to the invention, at least one solid lubricant (c) is a transition metal dichalcogenide, preferentially molybdenum bisulphide MoS2 or tungsten bisulphide WS2 with an inorganic fullerene structure. Preferentially, in the grease compositions according to the invention, the solid lubricants (c) are constituted by particles with a diameter comprised between 80 and 220 nm, preferentially between 100 and 200 nanometres. The grease composition according to the invention advantageously contains at least one anti-wear and/or extreme pressure additive (d) which is chosen from the esters of phosphoric, phosphorous, thiophosphoric or thiophosphorous acids, or their derivatives, the dithiophosphates, preferentially zinc or molybdenum dithiophosphates, the phosphorothionates, the amine phosphates.

According to a particularly preferred embodiment, the grease compositions according to the invention contain at least one anti-wear and/or extreme pressure additive (d) chosen from the zinc dithiophosphates of formula:

(R1O)(R2O)PS2 ZnS2P(R3O)(R4O), where

R1, R2, R3, R4 are, independently of each other, linear or branched alkyl groups comprising from 1 to 24, preferentially from 3 to 20 carbon atoms or aryl groups, optionally substituted, comprising from 6 to 30, preferentially from 8 to 18 carbon atoms.

According to another embodiment, the grease composition according to one of the claims of the invention contain at least one anti-wear and/or extreme pressure additive (d) chosen from the molybdenum dithiophosphates of formula:

(R5O)(R6O)SPS(MoS2)2 SPS(R7O)(R8O), where

R5, R6, R7, R8 are, independently of each other, linear or branched alkyl groups comprising from 1 to 24, preferentially from 3 to 20 carbon atoms or aryl groups, optionally substituted, comprising from 6 to 30, preferentially from 8 to 18 carbon atoms, optionally in combination with the abovementioned anti-wear and/or extreme pressure additives, in particular the abovementioned zinc dithiophosphates.

Preferentially, in the grease compositions according to the invention thickened with fatty acid metal soaps, said metal soaps are simple fatty acid metal soaps comprising from 14 to 28 carbon atoms, saturated or not, hydroxylated or not, and/or complex metal soaps of one or more fatty acids comprising from 14 to 28 carbon atoms, saturated or not, hydroxylated or not, in combination with one or more carboxylic acids with a short hydrocarbon chain comprising from 6 to 12 carbon atoms. Preferentially in the grease compositions according to the invention, the metal soaps of fatty acids are chosen from the soaps of titanium, aluminium, or of alkali and alkaline-earth metals, preferably lithium, calcium, sodium, barium. According to a preferred embodiment, the grease compositions according to the invention contain at least one base oil (a) which is an oil of synthetic origin, preferentially selected from the polyalphaolefins.

Preferentially, the base oil or the mixture of base oils (a) of the grease compositions according to the invention, has a kinematic viscosity at 40° C. according to standard ASTM D 445 comprised between 70 and 140 cSt, preferentially between 90 and 100 cSt. It is preferred to formulate grease compositions according to the invention the consistency of which according to standard ASTM D217, is comprised between 265 and 385 tenths of a millimetre, preferentially between 265 and 295, or between 310 and 340, or between 335 and 385 tenths of a millimetre, preferentially comprised between 310 and 340 tenths of a millimetre. Preferentially, the grease compositions according to the invention comprise:
from 70 to 94.8% by weight of one or more base oils (a)
from 5 to 20% by weight of one or more thickeners (b)
from 0.1 to 5% of one or more solid lubricants (c)
from 0.1 to 5% of one or more anti-wear and/or extreme pressure organophosphorus and/or organophosphorus-sulphur additives (d).

The present invention also relates to the use of the abovementioned grease compositions in the constant velocity joints of the transmissions of motor vehicles. The present invention also relates to constant velocity joints containing a grease composition as described previously.

### DETAILED DESCRIPTION

### Lubricating Base Oils

The other base oil or oils used in the compositions according to the present invention can be oils of mineral or synthetic origin of groups I to VI according to the classes defined in the API (American Petroleum Institute) classification. The mineral base oils according to the invention include all types of base oils obtained by atmospheric and vacuum distillation of crude oil, followed by refining operations such as solvent extraction, deasphalting, solvent dewaxing, hydrotreatment, hydrocracking and hydroisomerization, hydrofinishing. The base oils of the grease compositions according to the present invention can also be synthetic oils, such as certain esters, silicones, glycols, polybutene, polyalphaolefins (PAO). The base oils can also be oils of natural origin, for example esters of alcohol and of carboxylic acids, which can be obtained from natural resources such as sunflower, rapeseed, palm oil etc.

Preferentially, in the compositions according to the invention, synthetic oils of polyalphaolefin (PAO) type are present. The polyalphaolefins are for example obtained from monomers having 4 to 32 carbon atoms (for example octene, decene). Their average molecular mass by weight is typically comprised between 250 and 3000. The mixture of base oils is adjusted so that its viscosity at 40° C. according to standard ASTM D 445 is comprised between 40 and 140 cSt, preferentially between 90 and 100 cSt. To this end, it is possible to use a large range of light polyalphaolefins, such as for example PAO 6 (31 cSt at 40° C.), PAO 8 (48 cSt at 40° C.), or heavy polyalphaolefins, such as PAO 40 (400 cSt at 40° C.), or PAO 100 (1000 cSt at 40° C.).

### Thickeners

The greases according to the invention can be thickened with the thickeners conventionally used in the grease industry, namely mainly the metal soaps of fatty acids, and optionally inorganic thickeners such as bentonite or the aluminosilicates, or also the polyureas. The metal soaps of fatty acids can be prepared separately, or in situ during the manufacture of the grease (in the latter case, the fatty acid or acids is/are dissolved in the base oil, then the appropriate metal hydroxide is added). These thickeners are products commonly used in the field of greases, readily available and inexpensive. They offer the best technical compromise, combining good mechanical properties, good thermal resistance, and good water resistance.

Long-chain fatty acids typically comprising from 10 to 28 carbon atoms, saturated or unsaturated, optionally hydroxylated, are preferentially used. The long-chain fatty acids (typically comprising from 10 to 28 carbon atoms), are for example capric, lauric, myristic, palmitic, stearic, arachidic, behenic, oleic, linoleic, erucic acids, and their hydroxylated derivatives. 12-hydroxystearic acid is the best-known, and preferred, derivative in this category. These long-chain fatty acids generally originate from vegetable oils, for example palm, castor, rapeseed, sunflower oil etc. or from animal fats (suet, whale oil etc.).

It is possible to form so-called simple soaps using one or more long-chain fatty acids. It is also possible to form so-called complex soaps using one or more long-chain fatty acids in combination with one or more carboxylic acids with a short hydrocarbon chain comprising a most 8 carbon atoms. The saponification agent used to make the soap can be a metal compound of lithium, sodium, calcium, barium, titanium, aluminium, preferentially lithium and calcium, and preferably a hydroxide, oxide or a carbonate of these metals.

It is possible to use one or more metal compounds, having or not having the same metal cation, in the greases according to the invention. It is thus possible to use lithium soaps, combined with calcium soaps in a lesser proportion. This has the advantage of improving the water-resistance of the greases. The metal soaps are used in contents of the order of 5 to 20% by weight, preferentially 8 to 15% by weight, typically 12% by weight in the greases according to the invention. The quantity of metal soap(s) is generally adjusted so as to obtain greases of grade 0, grade 1 or grade 2 according to the NLGI classification.

Preferentially, the greases according to the invention contain in the majority metal soaps of fatty acids by way of thickener. By this is meant that the metal soaps of fatty acids, simple or complex, together represent the greatest percentage by weight in the greases according to the invention, compared with the percentage by weight of the other thickeners. Preferentially, the quantity of the metal soap or soaps of fatty acids, simple or complex, constitutes at least 50%, even more preferentially at least 80% by weight relative to the total weight of thickeners, in the grease compositions according to the invention.

According to an embodiment, the greases according to the invention can contain as thickener in the majority simple or complex metal soaps of fatty acids, and lesser quantities of other thickeners, such as the polyureas, or inorganic thickeners of the bentonite or aluminosilicate type. Preferentially, the greases according to the invention are free of thickeners of polyurea type. Less improvement in the friction properties is noted when friction modifiers of inorganic fullerene type are introduced into greases thickened with polyureas. Even more preferentially, the greases according to the invention exclusively contain simple or complex metal soaps of fatty acids as thickeners.

### Solid Lubricant

The solid lubricants used in the greases according to the invention are transition metal chalcogenides with an inorganic fullerene structure. In principle, the word fullerene denotes a closed convex polyhedron nanostructure, composed of carbon atoms. The fullerenes are similar to graphite, comprising sheets of linked hexagonal rings, but they contain some pentagonal rings, and sometimes heptagonal rings, which prevent the structure from being flat.

In the present application, a distinction is drawn between the fullerenes, closed structures, and nanotubes, open structures formed on the same principle. Studies of fullerene-type structures have shown that this structure was not limited to carbon-containing materials, but was capable of being produced in all nanoparticles of materials in lamellar form, in particular the transition metal chalcogenides. These structures are analogous to that of the carbon fullerenes and are called inorganic fullerenes or “Inorganic Fullerene-like materials”, also designated by “IF”.

There is a great deal of literature describing the structure and synthesis methods of these inorganic fullerenes, in particular:
Tenne, R., Margulis, L., Genut M. Hodes, G. Nature 1992, 360, 444,
Feldman, Y., Wasserman, E., Srolovitz, D. J. & Tenne, R. Science 1995, 267, 222,
Tenne, R. Nature Nanotech. 2006, 1, 103.
   The patent EP 0580 019 also describes these structures and their synthesis method.

These closed structures most often have a shape recalling that of a sphere, more or less perfect depending on the synthesis methods used, constituted by several concentric layers (“onion”—structure or “nested polyhedron”). The tribological properties of the inorganic fullerenes can generally be attributed to their quasi-spherical and onion-like structure, which allows them, instead of adhering to the contacts during friction, like laminar structures, to be exfoliated little by little, or to be deformed mechanically, hence their recommendation as solid lubricants. This spherical, onion-like structure exists in all the transition metal chalcogenides with an inorganic fullerene structure (see for example Tenne, R. Nature Nanotech. 2006, 1, 103 cited above).

Inorganic fullerenes with an onion-like structure are thus preferred in the field of lubrication and in the greases according to the invention. These are typically spheres of the order of 80 to 220 nm, containing a few tens of concentric layers, typically from 25 to 100 or 150 layers, or more.

The solid lubricants used in the greases according to the invention are transition metal chalcogenides. The transition metals can be for example tungsten, molybdenum, zirconium, hafnium, platinum, rhenium, titanium, tantalum, niobium, preferentially molybdenum or tungsten, and the chalcogen can be for example sulphur, selenium, tellurium, preferentially sulphur or tellurium. The transition metal chalcogenides can be for example MoS2, MoSe2, MoTe2, WS2, WSe2, ZrS2, ZrSe2, HfS2, HfSe2, PtS2, ReS2, ReSe2, TiS3, ZrS3, ZrSe3, HfS3, HfSe3, TiS2, TaS2, TaSe2, NbS2, NbSe2, NbTe2, studied for their tribological properties.

Preferentially, these are dichalcogenides, preferentially WS2, WSe2, MoS2, MoSe2. These chalcogenides can also contain several transition metals, such as for example the compounds described in the application WO 2009/034572. They can also have polymers grafted on their surface, for example polystyrene, methyl polymethacrylate etc. in order to improve their dispersion, or phosphate groups, so as to reinforce their anti-wear action.

Commercially, these compounds are often presented in the form of pastes containing approximately 75% by weight of metal chalcogenides with a fullerene structure and approximately 25% by weight of lubricating oil. Unless otherwise specified the percentages by weight indicated in the present application refer only to the metal chalcogenides. The grease compositions according to the invention preferentially comprise from 0.1 to 5% by weight of transition metal chalcogenides with a fullerene structure, preferentially from 0.2 to 2% by weight.

Organophosphorus-Sulphur and/or Organophosphorus Compounds

The phosphorus-sulphur and/or phosphorus compounds used in the greases according to the invention are preferentially chosen from the phosphorus-sulphur anti-wear and extreme pressure additives used in the formulation of greases and lubricants. These are for example, and non-limitatively, thiophosphoric acid, thiophosphorous acid, the esters of these acids, their salts, and the dithiophosphates, particularly the zinc or molybdenum dithiophosphates. Among the abovementioned compounds in particular only the organophosphorus-sulphur and organophosphorus compounds, better dispersed in the oily medium and more effective, will be retained in the greases according to the invention as anti-wear, and optionally extreme pressure additives. The inorganic compounds, such as for example the calcium phosphates, can be also used in the greases, but rather as thickeners.

There may be mentioned, by way of examples of anti-wear and extreme pressure phosphorus-sulphur additives, those which comprise from 1 to 3 sulphur atoms, such as monobutylthiophosphate, monooctylthiophosphate, monolaurylthiophosphate, dibutylthiophosphate, dilaurylthiophosphate, tributylthiophosphate, trioctylthiophosphate, triphenylthiophosphate, trilaurylthiophosphate, monobutylthiophosphite, monooctylthiophosphite, monolaurylthiophosphite, dibutylthiophosphite, dilaurylthiophosphite, tributylthiophosphite, trioctylthiophosphite, triphenylthiophosphite, trilaurylthiophosphite and their salts. Examples of salts of the esters of thiophosphoric acid and thiophosphorous acid are those obtained by reaction with a nitrogenous compound such as ammonia or an amine, for example amine phosphates, or zinc oxide or zinc chloride.

It is also possible to use, as organophosphorus-sulphur anti-wear compounds, the phosphorothionates, for example the triphenyl phosphorothionates, more preferentially those where the phenyl groups are substituted by alkyl groups. The organophosphorus-sulphur anti-wear compounds are preferred in the greases according to the invention, as the presence of sulphur promotes the extreme pressure properties of the greases. The lubricant compositions according to the present invention can also contain organophosphorus anti-wear and extreme-pressure additives, such as for example alkyl phosphates or alkyl phosphonates, mono-, di- and triesters of phosphorous acid and phosphoric acid, and their salts.

In particular zinc dithiophosphates of the following formula are preferred:

(R1O)(R2O)PS2 ZnS2P(R3O)(R4O), where

R1, R2, R3, R4 are, independently of each other, linear or branched alkyl groups comprising from 1 to 24, preferentially from 3 to 20 carbon atoms or aryl groups, optionally substituted, comprising from 6 to 30, preferentially from 8 to 18 carbon atoms.

Another class of preferred compounds are the molybdenum dithiophosphates of formula:

(R5O)(R6O)SPS(MoS2)2 SPS(R7O)(R8O), where

R5, R6, R7, R8 are, independently of each other, linear or branched alkyl groups comprising from 1 to 24, preferentially from 3 to 20 carbon atoms or aryl groups, optionally substituted, comprising from 6 to 30, preferentially from 8 to 18 carbon atoms.

These different compounds can be used alone or in a mixture in the grease compositions according to the invention. Their % by weight is preferentially comprised between 0.5 and 5% by weight, preferentially between 0.7 and 2% by weight, or also between 0.8 and 1.5% by weight with respect to the total weight of the composition

### Other Additives

The greases according to the invention can also contain any type of additives suited to their use, for example antioxidants, such as the aminated or phenolic antioxidants, antirust additives which can be oxygen-containing compounds such as esters and copper passivators. These different compounds are generally present in levels of less than 1%, or even 0.5% by weight in the greases. The greases according to the invention can also contain polymers, for example polyisobutene (FIB), in levels generally comprised between 5 and 10%, which confer an improved cohesiveness on the greases, which thus better resist centrifugation. These polymers also lead to a better adhesiveness of the grease to surfaces, and increase the viscosity of the base oil fraction and thus the thickness of the film of oil between the parts subject to friction.

### Method For the Preparation of the Greases

The greases according to the invention are preferentially manufactured by forming the metal soap in situ. One or more fatty acids are dissolved in a fraction of the base oil or mixture of base oil at ambient temperature. This fraction is generally of the order of 50% of the total quantity of oil contained in the final grease. The fatty acids can be long-chain acids, comprising from 14 to 28 carbon atoms, in order to form a simple soap, optionally combined with short-chain fatty acids, comprising from 6 to 12 carbon atoms, in order to form complex soaps.

Metal compounds, preferentially of the metal hydroxide type are added at a temperature of approximately 60 to 80° C. It is thus possible to add a single type of metal or to combine several metals. The preferred metal in the compositions according to the invention is lithium, optionally combined, in a lesser proportion, with calcium.

The saponification reaction of the fatty acids by the metal compound or compounds is left to take place at a temperature of approximately 100 to 110° C. The water formed is then evaporated by boiling the mixture at a temperature of approximately 200° C. The grease is then cooled down by the remaining base oil fraction. The additives are then incorporated at approximately 80° C., followed by kneading for a time sufficient to obtain a homogeneous grease composition.

### Grade of the Greases

The consistency of a grease is a measurement of its hardness or fluidity at rest. It is expressed in figures based on the depth of penetration of a cone of given dimensions and weight. The grease is kneaded beforehand. The conditions for measuring the consistency of a grease are defined by standard ASTM D 217.

Depending on their consistency, the greases are divided into 9 NLGI (National Lubricating Grease Institute) classes or grades commonly used in the field of greases. These grades are shown in the table below.

| | Consistency according to ASTM D |
|---|---|
| NLGI grade | 217 (tenths of a millimetre) |
| 000 | 445-475 |
| 00 | 400-430 |
| 0 | 335-385 |
| 1 | 310-340 |
| 2 | 265-295 |
| 3 | 220-250 |
| 4 | 175-205 |
| 5 | 130-160 |
| 6 | 85-115 |

The greases according to the invention are preferentially fluid or semi-fluid greases, with a consistency greater than 265 tenths of a millimetre, preferentially comprised between 265 and 385 tenths of a millimetre according to ASTM D217. Preferentially, they are of NLGI grade 0, 1 or 2, i.e. their consistency is respectively comprised between 335 and 385, or 310 and 340, or 265 and 295 tenths of a millimetre according to ASTM D217.

### EXAMPLES

### Example 1

### Preparation of the Grease Compositions

Grease compositions containing various friction modifiers and/or organophosphorus-sulphur compounds are prepared, from a base grease comprising mineral and synthetic base oils, thickened with lithium complex soap. The composition of the mixture leading to this base grease is indicated in Table 1 below. The term “base grease” commonly designates, for a person skilled in the art, a grease composition containing only base oils and thickeners, and no additive.

TABLE 1
Composition of the base grease

| Compound | % by weight |
|---|---|
| Mineral oils (150 NS + naphthenic) | 78.34 |
| Synthetic oils (PAO 6) | 8.89 |
| 12 hydroxystearic acid | 8.99 |
| Azelaic acid | 1.80 |
| Slaked lime | 0.24 |
| Lithium hydroxide | 1.73 |

The mixture of base oils is adjusted such that its viscosity at 40° C. according to standard ASTM D 445 is comprised between 40 and 140 cSt, preferentially between 90 and 100 cSt.

The fatty acid and lithium hydroxide contents indicated lead, after formation in situ, to soap contents in the base grease which are 9.2% lithium hydroxystearate and 1.91% lithium azelaate. The compositions by weight of the greases are given in Table 2:

| | (A)¹ | (B) | (C) | (D)¹ | (E) |
|---|---|---|---|---|---|
| Base grease | 91.29 | 91.64 | 90.96 | 92.74 | 89.99 |
| ZnDTP | 1.10 | 1.10 | 1.10 | — | 1.10 |
| MoDTC | 0.70 | — | — | — | — |
| WS2 fullerene* | — | 0.35 | 1.03 | 0.35 | 2.00 |
| PIB | 6.01 | 6.01 | 6.01 | 6.01 | 6.01 |
| Antioxidant | 0.90 | 0.90 | 0.90 | 0.90 | 0.90 |
| Antirust | | | | | |
| Cu passivators | | | | | |
| Content of the element | 2000 | — | — | — | — |
| Mo (calculated, in | | | | | |
| ppm) | | | | | |
| Content of the element | 0 | 2000 | 5886 | 2000 | 11428 |
| W (calculated, in ppm) | | | | | |
| Content of the element | 2000 | 680 | 2000 | 680 | 3886 |
| S (calculated, in ppm) | | | | | |
| provided by the FMs | | | | | |
| (WS2 or MoDTC) | | | | | |

¹Not according to the invention
*the % by weight indicated is that of a paste composed 75% by weight of nanometric WS2 fullerenes dispersed in a synthetic base oil (PAO 6).

### Example 2

### Comparison of the Frictional Properties of the Greases Prepared

The greases prepared in Example 1 were evaluated by measuring their coefficient of friction on a Cameron Plint tribometer cylinder/flat.

The tribometer test conditions are as follows:

Load: 50−100−150−200 N

Temperature of the grease: 75° C. (representative of operating temperatures).

Movable pin (cylinder): C steel with 25 nm roughness

Speed of movement: 5 and 15 mm/s

Plateaux: 50 N, 400 seconds at 5 mm/s
50 N, 200 seconds at 15 mm/s
100 N, 100 seconds at 5 mm/s and 100 seconds at 15 mm/s
150 N, 100 seconds at 5 mm/s and 100 seconds at 15 mm/s
200 N, 100 seconds at 5 mm/s and 100 seconds at 15 mm/s

The results of these tests are shown in Table 3 below. The coefficient of friction values correspond to the average of the last 40 seconds of each plateau.

TABLE 3
Coefficient of friction on a Cameron Plint tribometer

| Coefficient of | | | | |
|---|---|---|---|---|
| friction | (A) | (B) | (C) | (D) |
| 100N at 5 mm/s | 0.091 | 0.062 | 0.075 | 0.091 |
| 100N at 15 mm/s | 0.089 | 0.051 | 0.076 | 0.090 |
| 150N at 5 mm/s | 0.100 | 0.067 | 0.086 | 0.100 |
| 150N at 15 mm/s | 0.097 | 0.061 | 0.085 | 0.098 |
| 200N at 5 mm/s | 0.100 | 0.070 | 0.096 | 0.100 |
| 200N at 15 mm/s | 0.100 | 0.067 | 0.094 | 0.100 |

The addition of WS2 as a friction modifier to a Li complex grease, replacing MoDTC and in the absence of ZnDTP, allows a lowering of the coefficient of friction (cf. comparison of the greases A and D with a metal iso-content). The positive effect of the WS2 fullerene on the coefficient of friction is less if it is substituted for the MoDTC in a grease thickened with polyureas. The lowering of the coefficient of friction noted, in a lithium complex grease, with a fullerene-type WS2 friction modifier is however clearly more significant when it is used in combination with a organophosphorus-sulphur additive, here a ZnDTP.

### Example 3

### Comparison of the Wear Properties of the Prepared Greases

The anti-wear properties of the greases prepared in Example 1 were evaluated using the 4-ball wear test according to standard ASTM D2266. In this test, the wear is measured in millimetres: the lower the value, the better the anti-wear properties.

TABLE 4
Wear results

| | (A) | (B) N09/11 | (C) N09/126 | (D) |
|---|---|---|---|---|
| | N 30730 | (ZnDTP + | (ZnDTP + | N09/127 |
| | (ZnDTP + | WS2 | WS2 | (WS2 |
| | MoDTC) | fullerene) | fullerene) | fullerene) |
| 4-ball wear, 40 kg, | 0.36 mm | 0.40 mm | 0.39 mm | 0.71 mm |
| 1 hour (ASTM | | | | |
| D2266) | | | | |
| ZnDTP (% by | 1.10 | 1.10 | 1.10 | — |
| weight) | | | | |
| MoDTC (% by | 0.70 | — | — | — |
| weight) | | | | |
| WS2 fullerene* | — | 0.35 | 1.03 | 0.35 |
| (% by weight*) | | | | |
| Content of the | 0 | 2000 | 5886 | 2000 |
| element W | | | | |
| (calculated, in ppm) | | | | |
| Content of the | 2000 | 680 | 2000 | |
| element S provided | | | | |
| by the FM, WS2 | | | | |
| fullerene and | | | | |
| MoDTC | | | | |
| (calculated, in ppm) | | | | |

*the % by weight indicated is that of a paste composed 75% by weight of nanometric WS2 fullerenes dispersed in a synthetic base oil (PAO 6).

*the % by weight indicated is that of a paste composed 75% by weight of nanometric WS2 fullerenes dispersed in a synthetic base oil (PAO 6).

It is noted that the performances of the grease D, where inorganic fullerenes have been substituted for the anti-wear additives and friction modifiers, are very mediocre. By contrast, greases B and C have very good performances.

1. A grease composition comprising:
(a) one or more mineral, synthetic or natural base oils;
(b) a thickener;
(c) at least one solid lubricant including one or more transition metal chalcogenides with an inorganic fullerene structure; and
(d) at least one of: (i) one or more anti-wear additives, (ii) one or more and/of extreme pressure organophosphorus additives, or (iii) one or more and/or organophosphorus-sulphur additives.

2. The grease composition according to claim 1 wherein a majority of the thickener (b) is at least one fatty acid metal salt.

3. The grease according to claim 2 wherein the fatty acid metal salt(s) constitute at least 50% by weight of the thickener (b) in the composition.

4. The grease composition according to claim 1 wherein one or more transition metal chalcogenides with an inorganic fullerene structure have inorganic phosphate groups grafted on the surface.

5. The grease composition according to claim 1 wherein the chalcogen of at least one solid lubricant (c) is chosen from S, Se, or Te.

6. The grease composition according to claim 1 wherein the transition metals of at least one solid lubricant (c) are chosen from Mo, W, Zr, Hf, Pt, Re, Ti, Ta, or Nb.

7. The grease composition according to claim 1 wherein at least one solid lubricant (c) is a transition metal dichalcogenide.

8. The grease composition according to claim 1 wherein at least one solid lubricant (c) is molybdenum bisulphide MoS2 or tungsten bisulphide WS2 with an inorganic fullerene structure.

9. The grease composition according to claim 1 wherein the solid lubricants (c) include particles with a diameter comprised between 80 and 220 nm.

10. The grease composition according to one of claim 1 wherein at least one anti-wear and/or extreme pressure additive (d) is chosen from the esters of phosphoric, phosphorous, thiophosphoric or thiophosphorous acids, or their derivatives, the dithiophosphates, phosphorothionates, or the amine phosphates.

11. The grease composition according to claim 10 wherein at least one anti-wear and/or extreme pressure additive (d) is chosen from the zinc dithiophosphates of formula:
(R1O)(R2O)PS2 ZnS2P(R3O)(R4O), where
R1, R2, R3, R4 are, independently of each other, linear or branched alkyl groups comprising from 1 to 24 carbon atoms or aryl groups, optionally substituted, comprising from 6 to 30 carbon atoms.

12. The grease composition according to claim 10 wherein at least one anti-wear and/or extreme pressure additive (d) is chosen from the molybdenum dithiophosphates of formula:
(R5O)(R6O)SPS(MoS2)2 SPS(R7O)(R8O), where
R5, R6, R7, R8 are, independently of each other, linear or branched alkyl groups comprising from 1 to 24 carbon atoms or aryl groups, optionally substituted, comprising from 6 to 30 carbon atoms.

13. The grease composition according to claim 2 wherein the metal soaps are simple fatty acid metal soaps comprising from 14 to 28 carbon atoms, saturated or not, hydroxylated or not, and/or complex metal soaps of one or more fatty acids comprising from 14 to 28 carbon atoms, saturated or not, hydroxylated or not, in combination with one or more carboxylic acids with a short hydrocarbon chain comprising a maximum of 6 to 12 carbon atoms.

14. The grease composition according to claim 2 wherein the metal soaps of fatty acids are chosen from the soaps of titanium, aluminium, or of alkali and alkaline-earth metals, lithium, calcium, sodium, or barium.

15. The grease composition according to claim 1 wherein at least one base oil (a) is an oil of synthetic origin.

16. The grease composition according to claim 1 wherein the base oil or the mixture of base oils (a) has a kinematic viscosity at 40° C. according to standard ASTM D 445 comprised between 70 and 140 cSt.

17. The grease composition according to claim 1, the consistency of which according to standard ASTM D217 is comprised between 265 and 385 tenths of a millimetre.

18. The grease composition according to claim 1 comprising:
from 70 to 94.8% by weight of one or more base oils (a);
from 5 to 20% by weight of one or more thickeners (b);
from 0.1 to 5% of one or more solid lubricant (c); and
from 0.1 to 5% of one or more organophosphorus and/or organophosphorus-sulphur anti-wear and/or extreme pressure additives (d).

19. A method for lubricating a constant velocity joint of a transmission of a motor vehicle, the method comprising contacting a grease composition with the constant velocity joint of the motor vehicle, using the grease composition comprising:
(a) one or more mineral, synethic or natural base oils;
(b) a thickener;
(c) at least one solid lubricant constituted by one or more transition metal chalcogenides with an inorganic fullerene structure; and
(d) one or more additives selected from an: (i) anti-wear additive, (ii) extreme pressure organophosphorus additive, or (iii) organophosphorus-sulphur additive.

20. A constant velocity joint containing a grease composition, the grease composition comprising:
(a) one or more mineral, synethic or natural base oils;
(b) a thickener;
(c) at least one solid lubricant including one or more transition metal chalcogenides with an inorganic fullerene structure; and
(d) one or more anti-wear and/or extreme pressure organophosphorus and/or organophosphorus-sulphur additives.
